(19) United States
(12) Patent Application Publication
(10) Pub. No.: US 2013/0326112 A1
(43) Pub. Date: Dec. 5, 2013

(54) COMPUTER SYSTEM HAVING NON-VOLATILE MEMORY AND METHOD OF OPERATING THE COMPUTER SYSTEM

(71) Applicants: Young-Jin Park, Incheon (KR); II-guy Jung, Hwaseong-si (KR)

(72) Inventors: Young-Jin Park, Incheon (KR); II-guy Jung, Hwaseong-si (KR)

(21) Appl. No.: 13/790,036

(22) Filed: Mar. 8, 2013

(30) Foreign Application Priority Data
May 31, 2012 (KR) 10-2012-0058809

(51) Int. Cl. G06F 3/06

(52) U.S. Cl. CPC G06F 3/0679
USPC 711/102

(57) ABSTRACT

A computer system includes a central processing unit (CPU), a main memory including a non-volatile memory, and a memory reset controller controlling the main memory. If a memory reset command is input from outside, while the computer system is powered on/off, the memory reset controller deletes data stored in the main memory.

### CROSS-REFERENCE TO RELATED APPLICATIONS

This application claims priority to Korean Patent Application No. 10-2012-0058809, filed on May 31, 2012, in the Korean Intellectual Property Office, the disclosure of which is incorporated by reference in its entirety herein.

### BACKGROUND

1. Technical Field

The inventive concept relates to a computer system, and more particularly, to a computer system including a main memory implemented with a non-volatile memory and a method of operating the computer system.

2. Discussion of Related Art

A semiconductor memory device as a device for storing information may be classified into a volatile memory device and a non-volatile memory device. A volatile memory requires power to maintain stored information and a non-volatile memory retains stored information without power. A dynamic random access memory (DRAM) is an example of the volatile memory, which may be used as a main memory. A hard disk drive (HDD) and a flash memory are examples of the non-volatile memory, which may be used as an auxiliary storage device. Recently, attempts have been made to replace the DRAM as the main memory with a non-volatile memory. However, it can be difficult to operate a non-volatile memory as a main memory.

### SUMMARY

At least one embodiment of the inventive concept provides a computer system that uses a non-volatile memory as a main memory and controls whether to delete system data stored in the main memory when the computer system is powered on/off, and a method of operating the computer system.

According to an exemplary embodiment of the inventive concept, a computer system includes a central processing unit (CPU), a main memory including a non-volatile memory, and a memory reset controller controlling data stored in the main memory to be deleted when a memory reset command is input from outside.

According to an exemplary embodiment of the inventive concept, a method of operating a computer system includes receiving a termination command of the computer system, determining whether the termination command is a memory reset command, and if the termination command is the memory reset command, deleting data stored in the main memory including a non-volatile memory before rebooting of the computer system is completed.

According to exemplary embodiment of the inventive concept, a method of operating a computer system includes performing a self test operation when power is supplied to the computer system, deleting data stored in a main memory including a non-volatile memory based on a result of determining a flag value in the self test operation, and copying an operating system for driving the computer system to the main memory to activate the operating system.

According to an exemplary embodiment of the invention, a computer system includes a ROM having system data including an operating system OS, a main memory having a non-volatile memory comprising user data, a central processing unit configured to load the system data from the ROM into the main memory upon application of power to the system, and a controller configured to execute a command triggered by an external input. Execution of the command deletes only the system data from the main memory and retains the user data.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a computer system according to an exemplary embodiment of the inventive concept;

FIG. 2 is a block diagram of a main memory illustrated in FIG. 1, according to an exemplary embodiment of the inventive concept;

FIG. 3 is a circuit diagram of a cell array illustrated in FIG. 2, according to an exemplary embodiment of the inventive concept;

FIG. 4 is a stereoscopic diagram of a spin transfer torque magneto resistive random access memory (STT-MRAM) cell as a memory cell included in a main memory illustrated in FIG. 3, according to an exemplary embodiment of the inventive concept;

FIG. 5 illustrates a monitor screen of a computer system according to an exemplary embodiment of the inventive concept;

FIGS. 6A through 6D illustrate a method of deleting data stored in a main memory, according to an exemplary embodiment of the inventive concept;

FIG. 7 illustrates a state of the main memory before and after the data is deleted from the main memory, respectively, according to an exemplary embodiment of the inventive concept;

FIG. 8 is a block diagram of a main board of a computer system, according to an exemplary embodiment of the inventive concept;

FIG. 9 is a flowchart illustrating a method of terminating the computer system, according to an exemplary embodiment of the inventive concept;

FIG. 10 is a flowchart illustrating a method of booting the computer system, according to an exemplary embodiment of the inventive concept;

FIG. 11 illustrates a memory map of a MRAM according to an exemplary embodiment of the inventive concept;

FIG. 12 is a flowchart illustrating a method of booting the computer system, according to an exemplary embodiment of the inventive concept;

FIG. 13 illustrates a computer system according to an exemplary embodiment of the inventive concept;

FIG. 14 is a block diagram of an internal structure of the computer system illustrated in FIG. 13, according to an exemplary embodiment of the inventive concept;

FIGS. 15A through 15C are flowcharts illustrating a method of deleting data stored in a main memory of a desktop illustrated in FIG. 14, according to an exemplary embodiment of the inventive concept;

FIG. 16 illustrates a memory module including a non-volatile memory according to an exemplary embodiment of the inventive concept; and

FIG. 17 is a block diagram of a computer system according to an exemplary embodiment of the inventive concept.

### DETAILED DESCRIPTION

Hereinafter, the inventive concept will be described in detail by explaining exemplary embodiments thereof with reference to the attached drawings. The inventive concept may, however, be embodied in many different forms and should not be construed as limited to the exemplary embodiments set forth herein. In the drawings, the sizes and relative sizes of layers and regions may be exaggerated for clarity. Like reference numerals in the drawings denote like elements. As used herein, the singular forms of “a”, “an”, and “the” are intended to include the plural forms as well, unless the context clearly indicates otherwise.

The methods of the inventive concept described below can be embodied as computer readable codes on a computer readable recording medium. The medium is any data storage device that can store data which can be thereafter read by a computer system. For example, the medium may include program storage device such as a hard disk, magnetic floppy disk, RAM, ROM, CD ROM, etc., and be executable by and device or machine comprising suitable architecture, such as a general purpose digital computer having a processor, memory, and input/output interfaces.

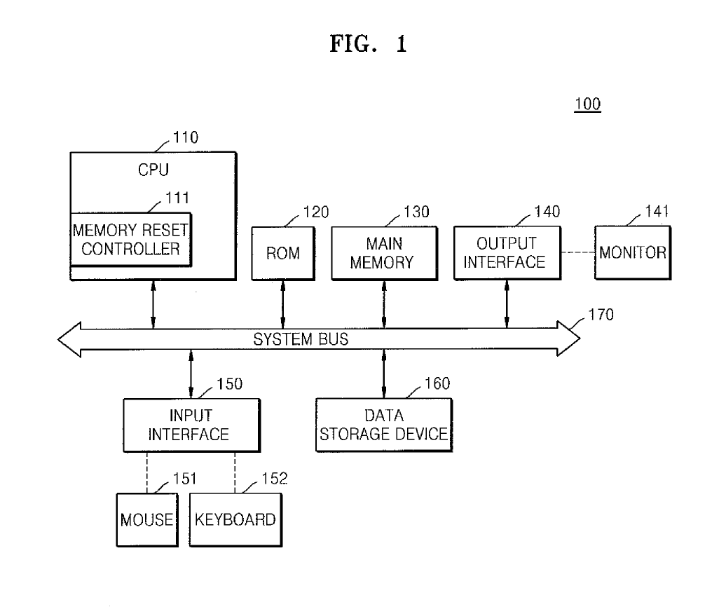

FIG. 1 is a block diagram of a computer system 100 according to an exemplary embodiment of the inventive concept. Referring to FIG. 1, the computer system 100 according to the present embodiment may be implemented with a personal computer (PC), such as a desktop, or a mobile computer device including a main memory, such as a notebook, a netbook, a tablet PC, a smartphone, or the like. The computer system 100 may include a central processing unit (CPU) 110, a read only memory (ROM) 120, a main memory 130, an output interface 140, an input interface 150, and a data storage device 160 that are electrically connected to a system bus 170, or the like.

The CPU 110 may control the entire operation of the computer system 100. In addition, the CPU 100 includes a memory reset controller 111 for controlling a memory installed in the computer system 100. For example, the memory reset controller 111 may perform a function of controlling an operation of deleting data stored in the main memory 130. In FIG. 1, the memory reset controller 111 is installed in the CPU 110 and is connected to the main memory 130 via a system bus 170. However, embodiments of the inventive concept are not limited thereto. For example, the main memory 130 may be a memory system including a memory controller (not shown) where a function of the memory reset controller 111 is performed by the memory controller (not shown). That is, the memory reset controller 111 may be included in the memory controller (not shown) for controlling the main memory 130. In this case, the memory reset controller 111 and the main memory 130 may be directly connected to each other so that a higher processing speed may be achieved.

The CPU 110 executes computer code copied to the main memory 130 from the ROM 120 or the data storage device 160 to execute a command corresponding to the computer code.

A basic input/output system (BIOS) code and/or an operating system may be stored in the ROM 120. A BIOS refers to a set of programs for processing a basic function of the computer system 100, and the BIOS code may be a unit for configuring the set of programs. The BIOS code is copied to the main memory 130 if the computer system 100 is powered on, and initialization of the computer system 100 is performed by executing the BIOS code by using the CPU 110. If the main memory 130 is implemented with a non-volatile memory, such as a dynamic random access memory (DRAM), the BIOS code has to be copied to the main memory 130 whenever the computer system 100 is powered on. However, when the main memory 130 is implemented with a non-volatile memory, the BIOS code need only be copied to the main memory 130 from the ROM 120 if system data stored in the main memory 130 is deleted.

The main memory 130 may be implemented with a non-volatile memory, such as phase change random access memory (PRAM) using a phase change material, a resistive random access memory (RRAM), a magnetic random access memory (MRAM), or a ferroelectric random access memory (FRAM). The RRAM may use a variable resistance material, such as complex metal oxides. The MRAM may use a ferromagnetic material. The FRAM may use a ferroelectric capacitor. The main memory 130 may store system data or frequently-accessed data, and thus may need a high processing speed.

If the main memory 130 is implemented with a volatile memory, all data stored in the main memory 130 is deleted during a reset operation in which the computer system 100 is powered on/off, and if power is subsequently applied to the computer system 100, a program is newly stored in the main memory 130. However, if the main memory 130 is implemented with a non-volatile memory, even when the computer system 100 is powered on/off, the data stored in the main memory 130 is retained. When an error occurs during an operation of the computer system 100, the data stored in the main memory 130 is retained even when the computer system 100 is rebooted. Thus, the same error may occur repeatedly. Further, if the error is a fatal error, the computer system 100 may stop operating.

According to an exemplary embodiment of the inventive concept, the computer system 100 is operated to prevent the same error from occurring repeatedly. The computer system 100 includes a booting function, which can delete data stored in the main memory 130. For example, all or a part of the data stored in the main memory 130 may be deleted when the computer system 100 is terminated or whenever the computer system 100 is booted regardless of generation of errors, or the same error may be prevented from occurring repeatedly by deleting the data stored in the main memory 130 when the error occurs.

The data storage device 160 may have a large capacity for storing data. The data storage device 160 may be implemented with a solid state drive (SSD), a hard disk drive (HDD), a PRAM, a RRAM, a MRAM, a FRAM, or the like. For example, the data storage device 160 and the main memory 130 of the computer system 100 may be implemented with the same type of memory.

The output interface 140 is hardware for showing an output result of the computer system 100 to a user. The output interface 140 may include a graphic processing unit (not shown), such as a graphics card, and a display module (not shown), such as a liquid crystal display (LCD) monitor. For example, the output interface 140 allows a monitor 141 to be connected to the system bus 170 so as to drive the monitor 141.

The input interface 150 allows a mouse 151 and a keyboard 152 to be connected to the system bus 170 so as to allow the user to input commands and data. Although not shown in FIG. 1, the computer system 100 may further include an application chipset, a modem, a camera image processor (CIS), and an input/output device, such as a microphone, a speaker, or the like.

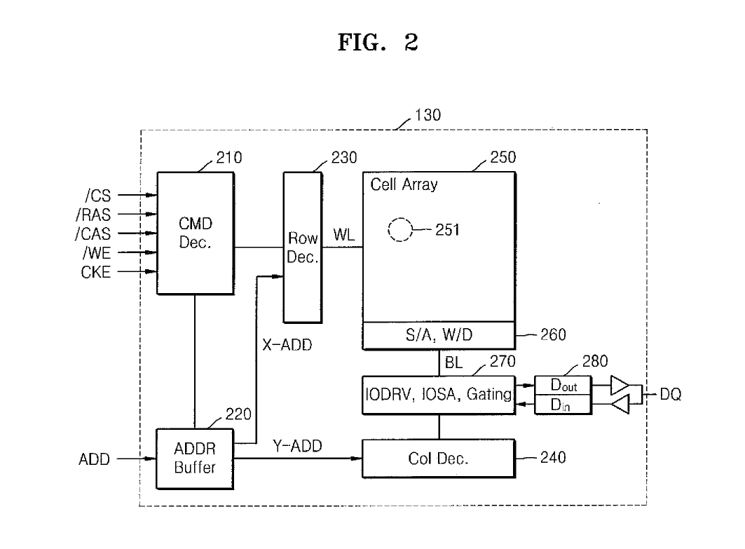

FIG. 2 is a block diagram of the main memory 130 illustrated in FIG. 1, according to an exemplary embodiment of the inventive concept. The main memory 130 may need a high processing speed at which data required by the CPU 110 is quickly accessed. In FIG. 2, the main memory 130 has non-volatile storage characteristics and is implemented by using an MRAM including a spin transfer torque magnetic random access memory (STT-MRAM) having a high access speed. However, the invention concept is not limited thereto, as the main memory 130 could be another type of MRAM, a PRAM, a RRAM, an FRAM, etc.

Referring to FIGS. 1 and 2, the main memory 130 includes a command decoder 210, an address buffer 220, a row decoder 230, a column decoder 240, a cell array 250, a write drive/sense amplifier 260, an input/output driver unit 270, and a data input/output unit 280.

The command decoder 210 receives a chip select signal /CS, a row address strobe signal /RAS, a column address strobe signal /CAS, a write enable signal /WE, and a clock enable signal CKE that are received from the CPU 110 (or the memory controller) and performs a decoding operation on the received signals. In an exemplary embodiment, one or more of the signals illustrated in FIG. 2 as being received by the command decoder 210 may be omitted. After the decoding operation is completed, the main memory 130 is controlled to execute commands of the CPU 110.

An address signal ADD that is received from the CPU 110, is stored in the address buffer 220. Subsequently, the address buffer 220 transmits a row address signal X-ADD to the row decoder 230 and transmits a column address signal Y-ADD to the column decoder 240.

Each of the row decoder 230 and the column decoder 240 may include a plurality of switches. In an exemplary embodiment, the switches are based on a metal-oxide-semiconductor (MOS) transistor. The row decoder 230 selects wordlines WL in response to the row address signal X-ADD, and the column decoder 240 selects bitlines BL in response to the column address signal Y-ADD. The cell array 250 includes a plurality of STT-MRAM cells 251 that are disposed in areas in which the wordlines WL and the bitlines BL cross one another.

The plurality of STT-MRAM cells 251 are resistive memory cells having non-volatile characteristics. The STT-MRAM cells 251 have relatively high or small resistances according to the written data.

When a data reading operation is performed, data voltages that are at different levels, are generated according to the resistances and are applied to the write drive/sense amplifier 260. The write drive/sense amplifier 260 includes a plurality of sense amplification circuits that sense/amplify the data voltages, and outputs data signals at digital levels based on the data voltages. The data signals that are processed by the write drive/sense amplifier 260, are transmitted to the data input/output unit 280 via the input/output driver unit 270. The data input/output unit 280 outputs the transmitted data signals to a source outside the main memory 130.

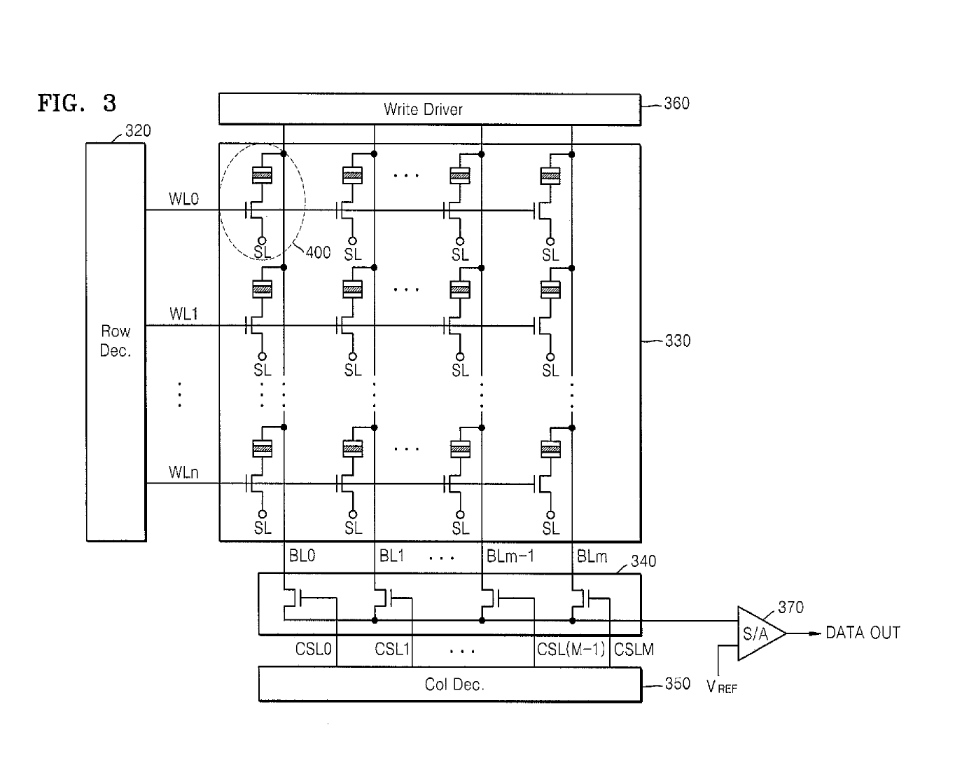

FIG. 3 is a circuit diagram of the cell array 250 illustrated in FIG. 2, according to an exemplary embodiment of the inventive concept. Referring to FIG. 3, a cell array 330 according to the present embodiment includes a plurality of wordlines WL0 to WLn (where n is a natural number that is equal to or greater than 1), a plurality of bitlines BL0 to BLm (where m is a natural number that is equal to or greater than 1), and a plurality of memory cells 400 that are disposed in areas in which the plurality of wordlines WL0 to WLn and the bitlines BL0 to BLm cross one another. When each of the plurality of memory cells 400 is implemented with an STT-MRAM cell, each memory cell 400 may include a magnetic tunnel junction (MTJ) device having a magnetic material.

Each memory cell 400 may include a cell transistor and an MTJ device. The cell transistor is switched in response to wordline signals that are output from the row decoder 320. In addition, a cell transistor and an MTJ device of each memory cell 400 are connected between one among the bitlines BL0 to BLm and source lines SL. Although not shown in FIG. 3, the plurality of memory cells 400 may be commonly connected to the same source line SL. Alternatively, the cell array 330 may be divided into at least two cell regions, and different source lines SL may be connected to each of the cell regions. For example, all the memory cells 400 in one of the cell regions may be commonly connected to one of the source lines SL and all the memory cells 400 in another one of the cell regions may be commonly connected to another one of the source lines SL.

The MTJ devices may be replaced with resistive devices, such as PRAMs, RRAMs, and FRAMs. Resistances of materials used in forming the resistive devices are changed according to magnitudes and/or directions of currents or voltages and have non-volatile characteristics that the resistances of materials are maintained even when the currents or voltages are cut off.

The plurality of bitlines BL0 to BLm are connected to the write driver 260. The write driver 360 may apply a current used for performing a write operation to the memory cell 400 in response to external commands.

The column decoder 350 may generate column select signals CSL0 to CSLm and may select one among the bitlines BL0 to BLm. When the data reading operation is performed, the data voltages that are affected by the resistances of the memory cell 400, are transmitted to a sense amplifier 370 via the bitlines BL0 to BLm. The sense amplifier 370 may sense and amplify a difference between a reference voltage V_{REF} and the data voltages and may output a digital signal as a result of sensing and amplifying the voltage difference.

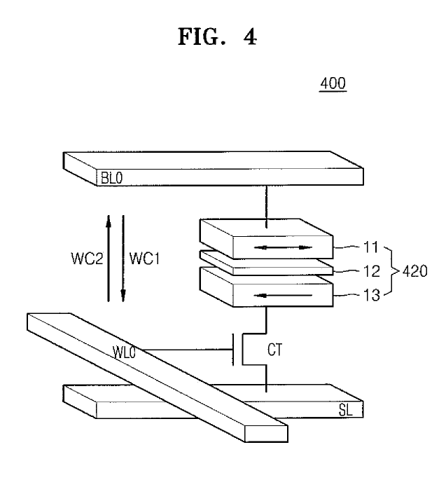

FIG. 4 is a stereoscopic diagram of an STT-MRAM cell 400 as a memory cell included in the main memory illustrated in FIG. 3, according to an exemplary embodiment of the inventive concept. Referring to FIG. 4, the STT-MRAM cell 400 according to the present embodiment may include a magnetic tunnel junction (MTJ) device 420 and a cell transistor CT. A gate of the cell transistor CT is connected to a wordline, for example, a first wordline WL0, and one electrode of the cell transistor CT is connected to a bitline, for example, a first bitline BL0, via the MTJ device 420. In addition, another electrode of the cell transistor CT is connected to the source line SL.

The MTJ device 420 may include a free layer 11, a fixed layer 13, and a tunnel layer 12 that is interposed between the free layer 11 and the fixed layer 13. A magnetization direction of the fixed layer 13 is fixed, and a magnetization direction of the free layer 13 may be the same as or opposite to the magnetization direction of the fixed layer 13 according to certain conditions. The MTJ device 420 may further include, for example, an anti-ferromagnetic layer (not shown) to fix the magnetization direction of the fixed layer 13.

A resistance of the MTJ device 420 is changed according to the magnetization direction of the free layer 11. For example, when the magnetization direction of the free layer 11 is the same as the magnetization direction of the fixed layer 13, the MTJ device 420 may have a low resistance and may store data corresponding to a logic low level. In addition, when the magnetization direction of the free layer 11 is opposite to the magnetization direction of the fixed layer 13, the MTJ device 420 may have a high resistance and may store data corresponding to a logic high level. In FIG. 4, the free layer 11 and the fixed layer 13 of the MTJ device 420 are represented as a horizontal magnetic devices. However, the inventive concept is not limited thereto, as the free layer 11 and the fixed layer 13 may be vertical magnetic devices.

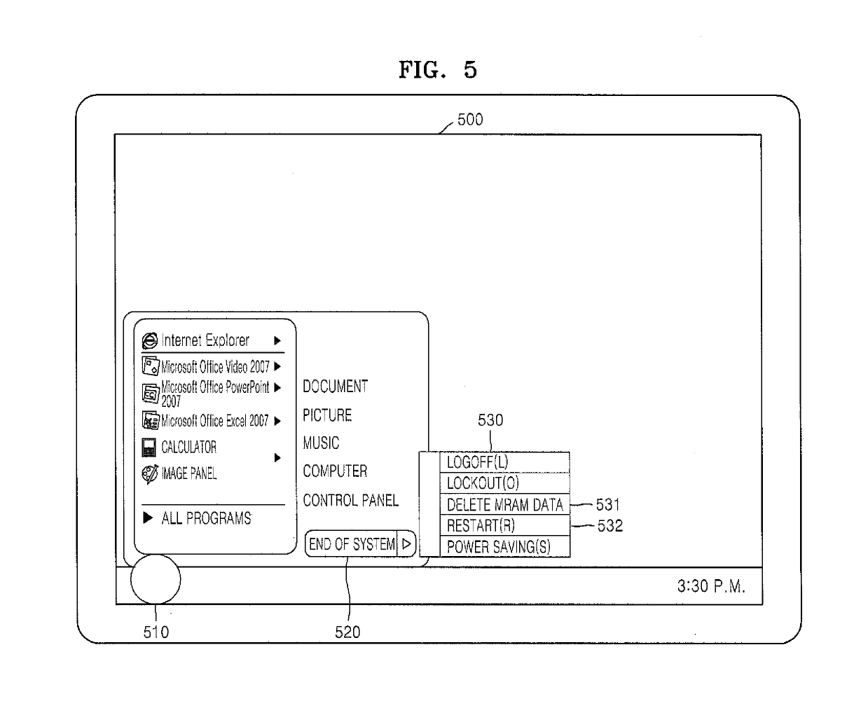

FIG. 5 illustrates a monitor screen of a computer system 100 according to an exemplary embodiment of the inventive concept. The computer system 100 may receive user commands by using an application program. For example, a user may input a reset command for powering off the computer system 100 and then for powering on the computer system 100, or a memory reset command for deleting data stored in a main memory that is implemented with a MRAM cell. The computer system 100 performs an operation of executing the received reset command or memory reset command. Hereinafter, it is assumed that the main memory 130 is implemented with an MRAM for ease of discussion. However, as discussed above, the invention concept is not limited thereto, as the main memory 130 may be a PRAM, a RRAM, FRAM, etc.

Referring to FIGS. 1 and 5, the computer system 100 may arrange control menus for performing various functions on a display of a monitor 500. A user of the computer system 100 may activate a start menu 510 that is disposed on the left lower end of the monitor 500 and designates the system end menu 520 so that a list window 530 may be generated. The illustration of the menus and the list window is merely an example. The start menu 510 could be disposed at any position within the monitor 500. While the system end menu 520 is entitled “END OF SYSTEM” it could have any label and need not be launched by the start menu 520. The entries of the list window 530 may have different labels from those illustrated, fewer entries, additional entries, etc. The system end menu 520 may be omitted and thus the start menu 510 could be used to launch the list window 530 directly.

A restart menu 532 on the list window 530 has a function of powering off the computer system 100 and then supplying power to the computer system 100, for example, cold booting.

Selection of an MRAM data deletion menu 531 on the list window 530 may execute a first function that deletes all data stored in the main memory 130 including an MRAM. In an exemplary embodiment, only portion of the data is deleted (e.g., codes for the driving the system such as a BIOS, operating system, device driver, etc.), while another portion of the data is retained (e.g., user data, user application, etc.). In an exemplary embodiment, selection of the MRAM data deletion menu 531 may also execute a second function powering off the computer system 100. When selection of the deletion menu 531 executes both functions, the data stored in the main memory 130 are deleted during a power off operation so that codes for driving the computer system 100 may be newly stored in the main memory 130 when future power is applied to the computer system 100. In an exemplary embodiment, selection of the MRAM data deletion menu 531 executes the first function to delete the data stored in the main memory and a fourth function that reboots the computer system 100. In this case, the data stored in the main memory 130 is deleted before rebooting of the computer system 100 is completed. The deletion may delete all the data in the main memory or only a portion.

If the MRAM data deletion menu 531 is selected, a value of a flag for indicating to delete the data stored in the main memory 130 may be stored in the computer system 100. For example, a state value, such as MRAMINTCHK=1, may be stored in a flag. The flag may be stored in memory. For example, a dedicated region of the main memory 130 may store the flag, or the flag may be inserted in a bias code for driving the computer system 100. The operation of generating and storing the flag may be controlled by the CPU 110 or a controller disposed in the main memory 130, and the flag may be stored due to selection of the MRAM data deletion menu 531, or a sudden cut-off of power that will be described later.

After the flag is stored, the computer system 100 may be powered off. Subsequently, the computer system 100 is powered on so that a value of the flag included in the bias code, or a value of the flag stored in the particular region of the main memory 130 may be determined and the data stored in the main memory 130 may be deleted based on the flag value while a booting program is executed.

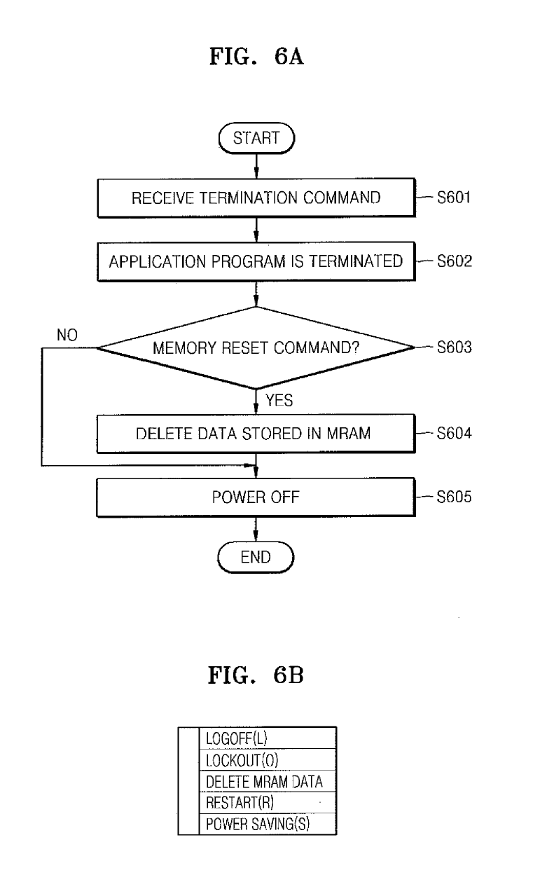

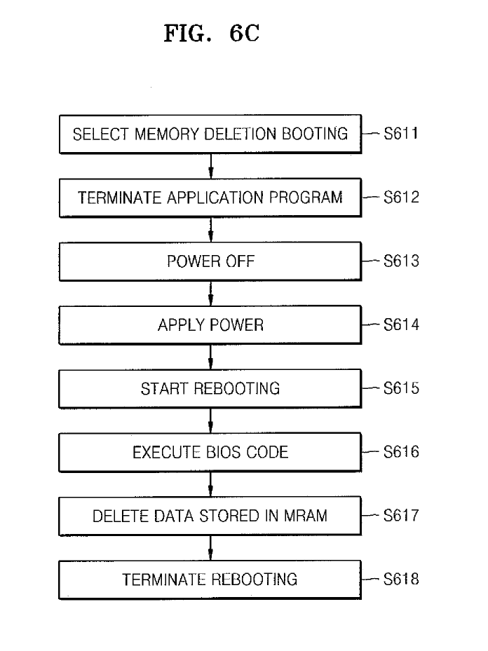

FIGS. 6A through 6D illustrate a method of deleting data stored in a main memory, according to an exemplary embodiment of the inventive concept, and FIG. 7 illustrates a state of the main memory before and after the data is deleted from the main memory, respectively, according to an exemplary embodiment of the inventive concept. Since a main memory that is implemented with an MRAM, has non-volatile characteristics, data stored in the main memory is retained regardless of when a power on/off of the computer system 100 has occurred. Thus, if an error occurs in the computer system 100, all the data can be deleted from the main memory to prevent the error from recurring.

Referring to FIGS. 1, 6A, and 7, the computer system 100 receives a termination command according to a user selection (S601). The termination command may instruct the performance of one among various types of termination operations, for example, a reset operation for rebooting the computer system 100, or a power off operation for powering off the computer system 100.

The computer system 100 terminates an application program upon receiving the termination command (S602). Along with terminating the application program, the computer system may terminate one or more services that were in progress. The application program and the services may be terminated sequentially. If an external device, such as a universal serial bus (USB) is connected to the computer system 100, it may be safely separated from the computer system 100. After terminating the application program, the computer system 100 may terminate the operating system (e.g., Windows, Linux, etc.).

The computer system 100 determines whether the applied termination command is a memory reset command (S603). The memory reset command may be a command that is generated by selecting the MRAM data deletion menu 531 illustrated in FIG. 5. If the termination command is a memory reset command, the computer system 100 deletes all the data stored in the main memory 130 (S604). In an exemplary embodiment, the computer system 100 could instead delete only a portion of the data stored in the main memory 130. The computer system 100 is then powered off (S605). However, if the termination command is not a memory reset command, the computer system 100 is powered off in a state where the data stored in the main memory 130 is retained (S605). When the data stored in the main memory 130 is retained, the previous screen may be output when power is applied to the computer system 100.

Referring to FIG. 7, the main memory 130 stores and retains system data regardless of a power on/off of the computer system 100. Thus, when a user's command is input to the computer system 100, or when a particular situation is detected during an operation of the computer system 100, the CPU 110 may generate an MRAM reset command and apply the MRAM reset command to the main memory 130. All the data stored in the main memory 130 may be deleted in response to the MRAM reset command A first state 130_1 of the main memory 130 of FIG. 7 represents a data allocation state of the main memory 130 before the data is deleted, and a second state 130_2 of the main memory 130 of FIG. 7 represents a state where all the data is deleted in response to the MRAM reset command. Subsequently, as power is applied to the computer system 100, an operating system of the computer system 100 is newly coped to the main memory 130.

In FIGS. 5 and 6A, the computer system 100 may operate to be powered off by the ‘MRAM data deletion’ menu 531. In addition, a rebooting function may be performed using a deletion function of the main memory 130, which will be described below in detail.

As illustrated in FIG. 6B, an MRAM deletion booting menu may be included as one among a plurality of menus disposed on the list window 530. The computer system 100 may be rebooted by selecting the MRAM deletion booting menu, and the data stored in the main memory 130 may be deleted before rebooting is completed so that an operating system of the computer system 100 is newly copied to the main memory 130.

Referring to FIG. 6C, the MRAM deletion booting is selected (S611), the application program is terminated (S612), and the computer system 100 is powered off (S613). A state value, such as MRAMINTCHK=1, is stored in a memory before the computer system 100 is powered off. The state value may be stored in a flag of the memory. The flag may be located in a dedicated location in the memory.

Power is applied to the computer system 100 subsequent to the power off operation (S614), a rebooting operation starts (S615), and a bios code is executed (S616). A value of the flag is checked while the BIOS code is executed, and the data stored in the main memory 130 is deleted according to a result of checking (S617). Thus, an operating system of the computer system 100 is newly copied to the main memory 130, and a subsequent rebooting operation is terminated (S618).

FIG. 6D is a modified version of FIG. 6A in which the data stored in the main memory 130 is deleted after the computer system 100 is powered off. As illustrated in FIG. 6D, the computer system 100 receives a termination command according to a user's selection (S621). An application program is terminated when the computer system 100 receives the termination command (S622). Along with the application program, one or more services that are in progress may be terminated. The application program and the services may be sequentially terminated. In addition, the computer system 100 determines whether the applied termination command is a memory reset command (S623). When the termination command is not a memory reset command, the computer system 100 is powered off in a state where the data stored in the main memory 130 is retained (S624).

When the termination command is a memory reset command, the computer system 100 deletes the data stored in the main memory 130 when it is powered off (S625). In an embodiment, the deletion and the powering off occur at substantially the same time or simultaneously. In an embodiment where basic power for system maintenance is consumed regardless of a power on/off of the computer system 100, or when an additional battery is provided in the computer system 100, an operation of controlling the main memory 130 may be performed. In this case, an operation of deleting the data stored in the main memory 130 may be performed after the computer system 100 is powered off. For example, hardware powered by the basic power or the additional power may be used to delete the data stored in the main memory 130 after the computer system 100 is powered off.

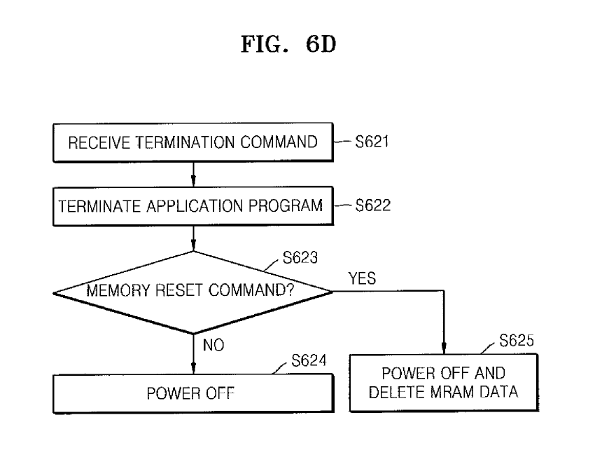

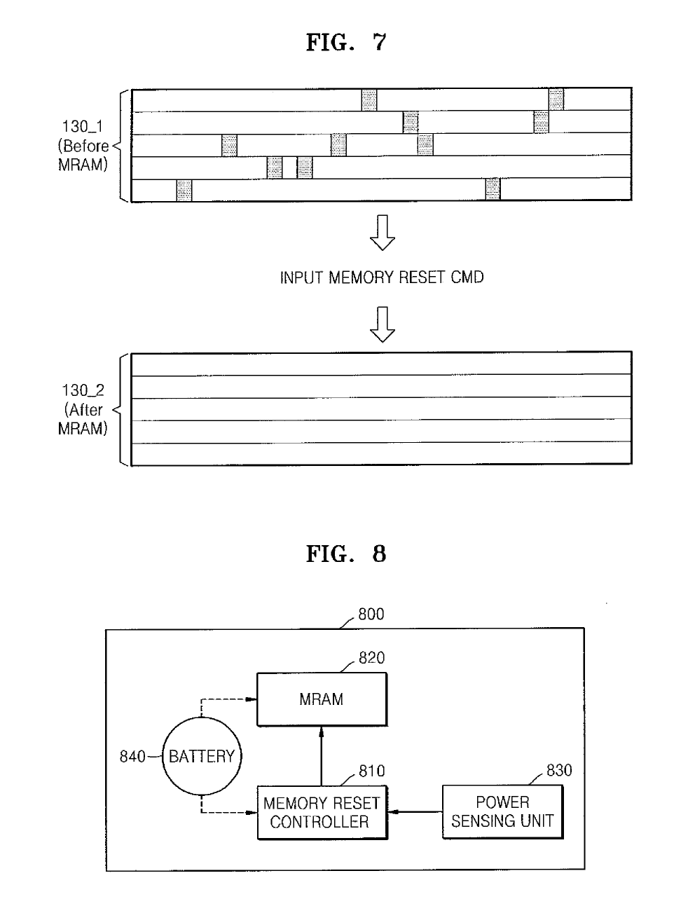

FIGS. 8 through 9 are related to a method of deleting data stored in the main memory 130 when a sudden power off (e.g., power failure) occurs in the computer system 100. The computer system 100 may be powered off before the data stored in the main memory 130 is deleted. However, it may be necessary to delete the data stored in the main memory 130 for security reasons. Thus, a power sensing unit for sensing power of the computer system 100 and a battery for generating auxiliary power may be additionally provided.

FIG. 8 is a block diagram of a main board 800 of the computer system 100, according to an exemplary embodiment of the inventive concept, and FIG. 9 is a flowchart illustrating a method of terminating the computer system 100, according to an exemplary embodiment of the inventive concept.

Referring to FIGS. 8 and 9, the computer system 100 includes a main board 800, and the main board 800 includes a memory reset controller 810, a main memory 820 that is implemented with an MRAM, a power sensing unit 830 that senses main power of the computer system 100, and a battery 840 that provides auxiliary power to the memory reset controller 810 and the main memory 820. The power sensing unit 830 may periodically sense or check to determine whether a level of the main power is a lower than a threshold value or is off entirely. The power sensing unit 830 may also perform this task in response to a user command (e.g., requesting deletion or data in memory, a reset, a power off, etc.).

Referring to FIG. 9, the power sensing unit 830 senses that a power supply (e.g., main power) has stopped (or is a below a threshold level) during an operation of the computer system 100 or input of a particular user command (e.g., a reset command, power off command, deletion of memory data command, etc.) (S901), and the battery 840 is driven (S902). The power sensing unit 830 may activate the battery 840 when it senses one of the above conditions. The memory reset controller 810 and the main memory 820 may operate by power supplied from the battery 840, and the memory reset controller 810 may generate a memory reset command in response to a result of the power sensing and may provide the generated memory reset command to the main memory 820. The main memory 820 deletes data stored in the main memory 820 in response to the memory reset command. That is, even after the computer system 800 is powered off, the entire system data stored in the main memory 840 may be deleted using auxiliary power, such as power supplied from the battery 840.

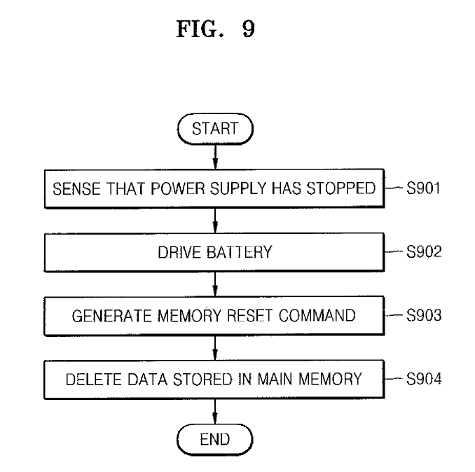

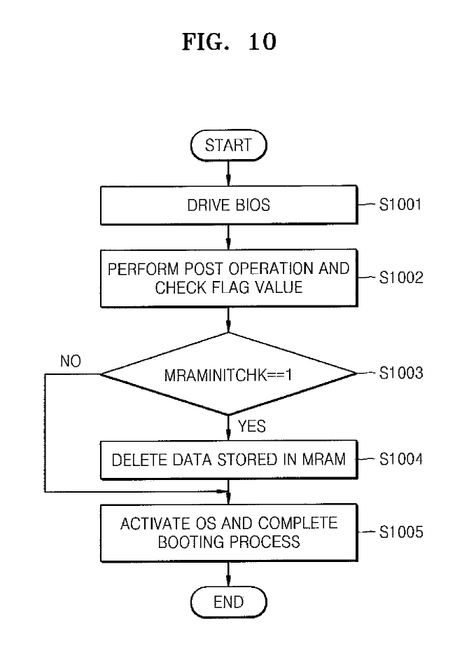

FIGS. 10 and 11 are related to a method of deleting all data stored in the main memory 130 that is implemented with an MRAM while a booting process of the computer system 100 is in progress. FIG. 10 is a flowchart illustrating a method of booting the computer system 100, according to an exemplary embodiment of the inventive concept, and FIG. 11 illustrates a memory map of an MRAM according to an exemplary embodiment of the inventive concept.

The main memory 130 that is implemented with an MRAM, has non-volatile characteristics and thus retains data regardless of a power on/off of the computer system 100. Thus, when an error occurs in the computer system 100, all data may need to be deleted to prevent the same error from occurring repeatedly.

Referring to FIGS. 1, 10, and 11, if power is supplied to the computer system 100, the CPU 110 hands over control of the computer system 100 to a basic input/output system (BIOS) (S1001). The BIOS is a program having the basic processing function of a computer and controls and manipulates communications between the computer and peripheral devices. In the booting process, the BIOS performs a power on self test (POST) that performs an operation of checking the state of the computer and starting an operation of the computer, and checks a state value of a flag stored in the BIOS or in the memory (S1002). The flag may be stored in a dedicated location within the memory. When a memory reset command is input to the computer system 100 due to a user's command or a particular situation is sensed due to a previous operation of the computer system 100, MRAMINTCHK=1 as a flag value is stored in the memory, and if the memory reset command is not input to the computer system 100, MRAMINTCHK=0 as a flag value is stored in the memory. A determination of whether MRAMINTCHK is equivalent to 1 is made (S1003).

If the flag value is MRAMINTCHK=1, the main memory 130 that is implemented with an MRAM, deletes all system data stored in the main memory 130 (S1004). Subsequently, according to the completion of the POST process, an operating system is activated and a booting process is completed (S1005). If the flag value is MRAMINTCHK=0, a process of deleting the system data stored in the main memory 130 may be omitted, and the booting process may be completed (S1005). That is, when the computer system 100 is booted, the main memory 130 may or may not delete all of the system data stored in the main memory 130 according to the flag value.

Referring to FIG. 11, the main memory 130 stores and retains the system data regardless of a power on/off of the computer system 100. After a flag value is checked when the computer system 100 is booted, if the flag value is MRAMINTCH K=1, all the data stored in the main memory 130 are deleted. Subsequently, an operating system of the computer system 100 is newly copied to the main memory 130. An example in which a flag is stored in a particular region of the main memory 130 and an example in which the flag is deleted by performing an operation of deleting the data stored in the main memory 130, are shown in FIG. 11. However, embodiments of the inventive concept are not limited thereto. For example, the flag may be stored in a region that is different from a region in which the system data is stored and thus the system data may be deleted without deleting the flag.

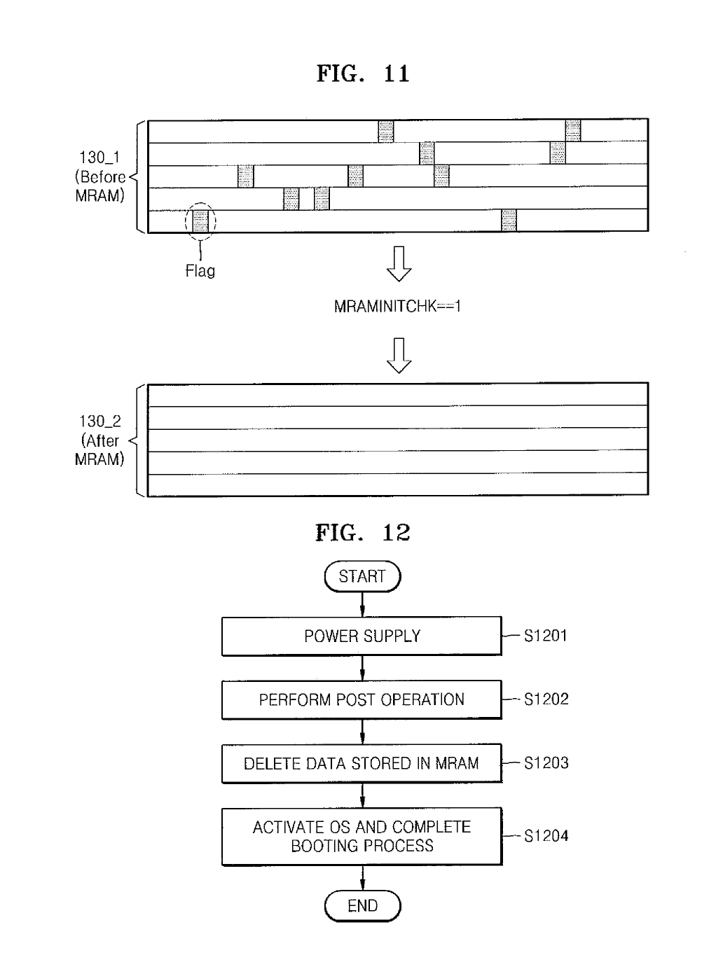

FIG. 12 is a flowchart illustrating a method of booting the computer system, according to an exemplary embodiment of the inventive concept. Referring to FIGS. 1 and 12, power is supplied to the computer system 100 (S1201), the CPU 110 performs a POST operation of checking a state of the computer and of starting an operation of the computer in a BIOS operation (S1202). In addition, all the system data stored in the main memory 130 that is implemented with an MRAM, is deleted (S1203). If the POST operation is completed, an operating system is activated and a booting process is completed (S1204). Accordingly, whenever the computer system 100 is booted, all the system data stored in the main memory 130 may be deleted.

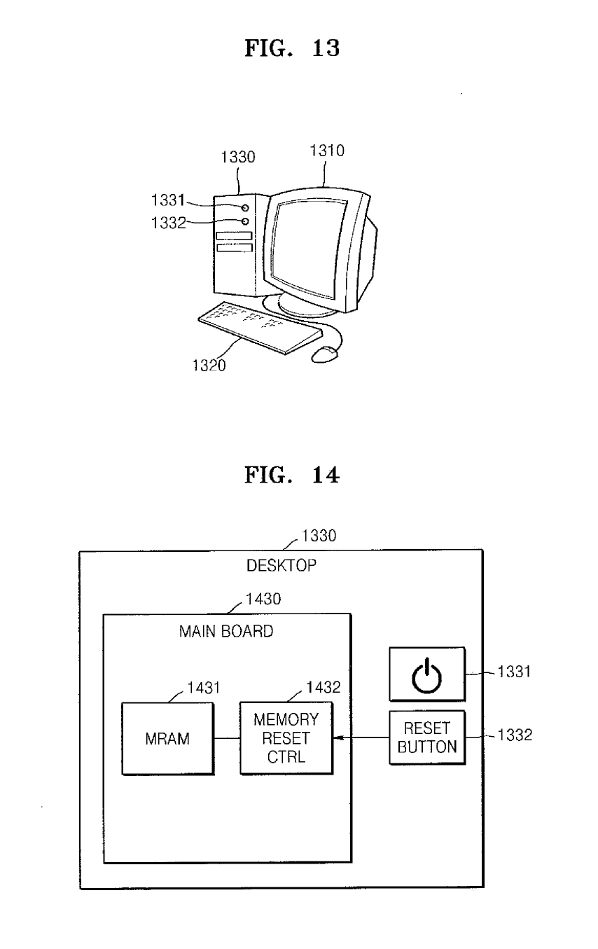

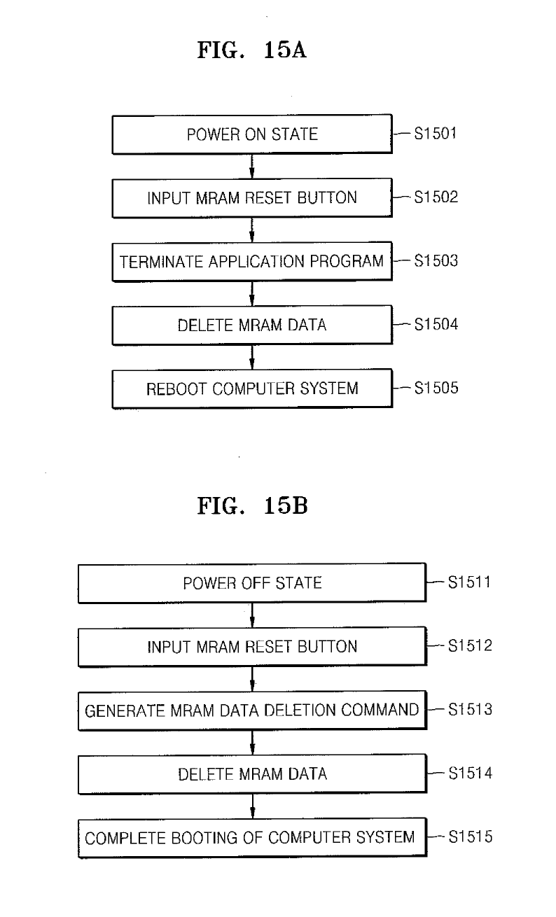

FIGS. 13 and 14 illustrate examples of a hardware interface for deleting data stored in a main memory. FIG. 13 illustrates a computer system according to an exemplary embodiment of the inventive concept, and FIG. 14 is a block diagram of an internal structure of the computer system illustrated in FIG. 13, according to an exemplary embodiment of the inventive concept.

FIGS. 13 and 14 are examples in which a computer system is implemented with a desktop 1330 including a main memory, a processor, and the like. As illustrated in FIG. 13, a monitor unit 1310 and a keyboard 1330 for the user interface may be connected to the desktop 1330. Alternatively, when the computer system according to the inventive concept is implemented with a mobile computing device having the same function, the user interface including the monitor unit 1310 and the keyboard 1330 may be implemented within the computer system.

In an exemplary embodiment of the inventive concept, the desktop 1330 may include a power button 1331 and an MRAM reset button 1332 that allow a user to facilitate an input. The power button 1331 is an input button for allowing the computer system to be powered on/off, and the MRAM reset button 1332 is an input button for deleting data stored in a main memory 1431 that is implemented with an MRAM cell. In addition, a main board 1430 is disposed in the desktop 1330, and the main memory 1431 is mounted on the main board 1430. A circuit, such as a microprocessor, and various other components may be mounted in the desktop 1330. As in the above-described embodiment, by using the MRAM reset button 1332, the desktop 1330 may be terminated in a state where the desktop 1330 is powered off, or power may be applied to the desktop 1330 after the desktop 1330 is powered off due to a rebooting operation.

A signal generated by selecting the MRAM reset button 1332 is transmitted to the memory reset controller 1432 mounted on the main board 1430, and the memory reset controller 1432 deletes data stored in the main memory 1431 that is implemented with an MRAM.

In an exemplary embodiment of the inventive concept, the MRAM reset button 1332 may be omitted from the desktop 1330 so that only the power button 1331 is present on the desktop 1330. In this case, if the power button 1331 is pressed once, the desktop 1330 is powered on/off. In an exemplary embodiment, an operation of deleting the system data stored in the main memory 1431 is applied by continuously pressing the power button 1331 (e.g., double-click, triple click, etc.). Alternatively, the power button 1331 may be set to be pressed first for a relatively long time and the next time for a relatively short time. In an exemplary embodiment, a long press powers off the desktop 1330 and a short press deletes the system data. Further, conditions that the power button 1331 needs to be pressed three or more times, may be modified in various ways.

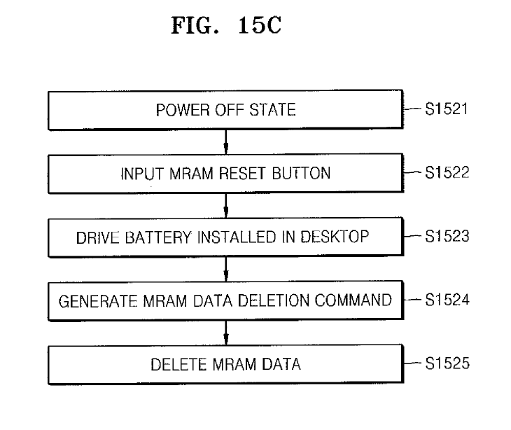

FIGS. 15A through 15C are flowcharts illustrating a method of deleting data from the main memory 1431 of the desktop 1330 illustrated in FIG. 14, according to an exemplary embodiment of the inventive concept. FIG. 15A shows a case where the MRAM reset button 1332 is selected in a state where the desktop 1330 is powered on, and FIGS. 15B and 15C show a case where the MRAM reset button 1332 is selected in a state where the desktop 1330 is powered off.

Referring to FIG. 15A, power is applied to the desktop 1330 (S1501), the MRAM reset button 1332 is selected in the power on state (S1502), and an application program is terminated (S1503). Along with the application program, a service that is in progress may be terminated. The application program and the service may be sequentially terminated. Data stored in the MRAM as the main memory 1431 is deleted before the desktop 1330 is powered off (S1504), and subsequently, a rebooting operation of the desktop 1330 is performed (S1505).

Although not shown, a flag value for instructing the deletion of data stored in the main memory 1431 before the desktop 1330 is powered off, may be stored, and after the desktop 1330 is powered off and then power is applied to the desktop 1330, an operation of checking the flag value and deleting data stored in the main memory 1431 may be performed.

Referring to FIG. 15B, power of the desktop 1330 is turned off (S1511), the MRAM reset button 1332 is selected in the power off state (S1512), power is applied to the desktop 1330, and an MRAM data deletion command for deleting the data stored in the main memory 1431 is generated (S1513). The data stored in the main memory 1431 is deleted in response to the MRAM data deletion command (S1514). Thus, a booting operation is completed by copying an operating system of the computer system to the main memory 1431 (S1515).

In FIG. 15B, when the user performs a general power off during the previous driving of the desktop 1330, an operation of the desktop 1330 may start from its initial screen in the next driving operation. For example, selection of the MRAM reset button 1332 is sensed by hardware and/or software inside the desktop 1330, and during the booting operation, data stored in the main memory 1431 is deleted, and the operating system of the computer system is newly copied to the main memory 1431 so that the initial screen of the desktop 1330 may be output.

Referring to FIG. 15C, power of the desktop 1330 is turned off (S1521), the MRAM reset button 1332 is selected in the power off state (S1522), and in response to the selection of the MRAM reset button 1332, an auxiliary battery installed in the desktop 1330 is driven so as to control an operation of the main memory 1431 (S1523). In addition, in response to the selection of the MRAM reset button 1332, an MRAM data deletion command for deleting the data stored in the main memory 1431 is generated (S1524), and the data stored in the main memory 1431 is deleted in response to the MRAM data deletion command (S1525). In FIG. 15C, unlike in FIG. 15B, even when the desktop 1330 is powered off, by using a battery (not shown) that is connected to the main memory 1431 and the memory reset controller 1432, the data stored in the main memory 1431 may be deleted. In addition, in the present embodiment, when the MRAM reset button 1332 is selected in the power off state, power for the booting operation is not applied to the desktop 1330 but only the data stored in the main memory 1431 is deleted using the battery inside the desktop 1330.

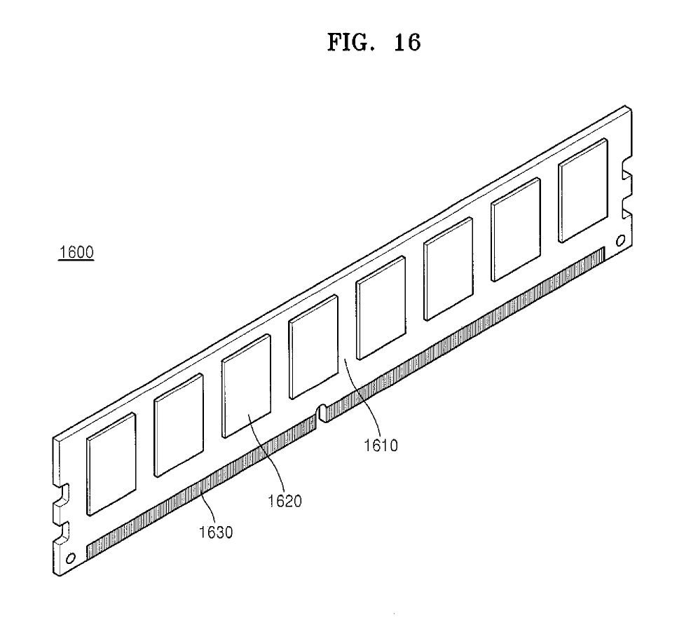

FIG. 16 illustrates a memory module including a non-volatile memory according to an exemplary embodiment of the inventive concept. Referring to FIG. 16, the memory module 1600 includes a printed circuit board (PCB) 1610, a plurality of MRAM chips 1620, and a connector 1630. The plurality of MRAM chips 1620 may be combined with top and bottom surfaces of the PCB 1610. The connector 1630 is electrically connected to the plurality of MRAM chips 1620 via conductive lines (not shown). In addition, the connector 1630 may be connected to slots formed in a main board of a computer system. At least one memory module illustrated in FIG. 16 is mounted on the main board of the computer system and thus may be used as a main memory of the computer system.

Although not shown, a controller (not shown) for controlling writing/deleting data stored in MRAM cells inside the MRAM chips 1620 may be provided inside the MRAM chips 1620 or may be implemented as an additional chip on the PCB 1610. In addition, the controller (not shown) may be disposed outside the memory module 1600. In addition, as described above, the whole or part of a function of the controller for controlling the MRAM chips 1620 may be performed by a CPU.

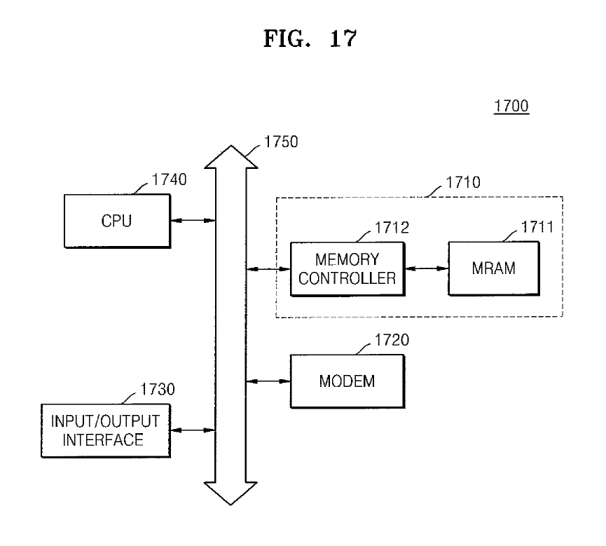

FIG. 17 is a block diagram of a computer system according to an exemplary embodiment of the inventive concept. Referring to FIG. 17, a non-volatile memory device 1711 may be mounted on a computer system 1700, such as a mobile device or a desktop computer. The computer system 1700 may include a memory system 1710 that is electrically connected to a system bus 1750, a modem 1720, an input/output interface 1730, and a CPU 1740. The non-volatile memory device 1711 may be an MRAM chip including an STT-MRAM cell, and the memory system 1710 may further include a memory controller 1712 for controlling an operation of writing/deleting data into/from the MRAM chip. The memory system 1710 may be used as a main memory of the computer system 1700, and an additional storage device for storing a large capacity of data may be further provided to the computer system 1700.

An MRAM as a non-volatile memory is a next-generation memory having characteristics, such as low cost and high capacity of a DRAM, an operation speed of an SRAM, and non-volatile characteristics of a flash memory. In at least one embodiment of the inventive concept, one MRAM may replace the above-described memories. Thus, large capacity data may be stored in a memory device including an MRAM so that a structure of a computer system may be simplified.

While some of the embodiments were described above with main memory comprising an MRAM, the invention concept is not limited thereto. For example, the main memory may instead comprise a PRAM, RRAM, or FRAM, or some other non-volatile memory.

While the inventive concept has been particularly shown and described with reference to exemplary embodiments thereof, it will be understood that various changes in form and details may be made therein without departing from the spirit and scope of the disclosure.

1. A computer system comprising:
a central processing unit (CPU);
a main memory comprising a non-volatile memory; and
a memory reset controller configured to control data stored in the main memory to be deleted when a memory reset command is input from outside.

2. The computer system of claim 1, wherein the non-volatile memory comprises a spin transfer torque magnetic random access memory (STT-MRAM).

3. The computer system of claim 1, wherein the memory reset controller is included in the central processing unit (CPU).

4. The computer system of claim 1, wherein the memory reset controller is included in a memory controller for controlling the main memory.

5. The computer system of claim 1, wherein the memory reset controller deletes data stored in the main memory before the computer system is powered off when the memory reset command is input.

6. The computer system of claim 1, wherein, when the memory reset command is input, the computer system is powered off after a flag having a first state value is stored in the computer system indicating that the data should be deleted.

7. The computer system of claim 6, wherein, if the computer system is powered off and then powered on again, the memory reset controller deletes the data stored in the main memory when the flag has the first state value.

8. The computer system of claim 1, further comprising an input interface for receiving the memory reset command from outside.

9. The computer system of claim 8, wherein the input interface receives the memory reset command that is input from a user by using a control menu that is software.

10. The computer system of claim 8, further comprising a memory reset button for deleting data stored in the main memory, wherein the input interface receives the memory reset command that is input via the memory reset button that is hardware.

11. The computer system of claim 10, wherein, if the memory reset command is received via the memory reset button in a state where the computer system is powered off, data stored in the main memory is deleted using a battery that is connected to the main memory and the memory reset controller.

12. The computer system of claim 8, further comprising a power button for controlling power on/off of the computer system, wherein data stored in the main memory is deleted in response to at least twice continuous selection of the power button.

13. (canceled)

14. (canceled)

15. (canceled)

16. (canceled)

17. (canceled)

18. A method of operating a computer system, the method comprising:
performing a self test operation when power is supplied to the computer system;
deleting data stored in a main memory comprising a non-volatile memory based on a result of determining a flag value in the self test operation; and
copying an operating system for driving the computer system to the main memory to activate the operating system.

19. The method of claim 18, wherein the deleting occurs if the flag value is in a first state, and does not occur if the flag value is in a second state.

20. The method of claim 19, wherein the flag value is stored before the computer system is powered off in response to receiving a memory reset command from outside.

21. A computer system comprising:
a read only memory ROM comprising system data include an operating system OS;
a main memory comprising a non-volatile memory including user data;
a central processing unit configured to load the system data from the ROM into the main memory upon application of power to the system; and
a controller configured to execute a command triggered by an external input, wherein execution of the command deletes only the system data from the main memory and retains the user data.

22. The computer system of claim 21, wherein the non-volatile memory comprises a spin transfer torque magnetic random access memory (STT-MRAM).

23. The computer system of claim 21, further comprising a monitor, wherein the OS comprises a program that displays a graphical user interface (GUI) on the monitor, and the external input is selection of a part of the GUI.

24. The computer system of claim 21, further comprising a physical button, and the external input is a signal received in response to depressing the physical button.
